(19) United States
(12) Patent Application Publication
(10) Pub. No.: US 2008/0292136 A1
(43) Pub. Date: Nov. 27, 2008

(54) Data Processing System And Method

(76) Inventors: Srinivasan RAMANI, Bangalore (IN); Darpan GOEL, Bangalore (IN); Sandeep K. GUPTA, Bangalore (IN); Anil KUMAR, Bangalore (IN); Antonio LAIN, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/109,374

(22) Filed: Apr. 25, 2008

(30) Foreign Application Priority Data
May 23, 2007 (IN) 1083/CHE/2007

(51) Int. Cl. G06K 9/00

(52) U.S. Cl. 382/100

(57) ABSTRACT

Embodiments of the invention provide a method of authenticating a physical document, comprising obtaining an electronic representation of at least part of the physical document; extracting at least one error detection code from the electronic representation; and using the at least one error detection code to detect errors in image data within the electronic representation. Embodiments of the invention also provide a method of securing a physical document, comprising obtaining an electronic representation of at least part of the physical document; determining at least one error detection code for image data within the electronic representation; and producing a secure physical document comprising the electronic representation and a machine readable marking including the at least one error detection code.

### RELATED APPLICATIONS

Benefit is claimed under 35 U.S.C. 119(a)-(d) to Foreign application Ser. 1083/CHE/2007 entitled “DATA PROCESSING SYSTEM AND METHOD” by Hewlett-Packard Development Company, L.P., filed on 23rd May, 2007, which is herein incorporated in its entirety by reference for all purposes.

### BACKGROUND TO THE INVENTION

A physical document, such as, for example, a property deed, land record or certificate, is often secured using, for example, a signature and/or rubber stamp such that its origin can be verified. Such means for securing can be easily forged. Furthermore, information on the physical document itself may be altered by a malicious user.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a method of securing a document according to embodiments of the invention;

FIG. 2 shows an example of a method of creating a canonical representation of a document;

FIG. 3 shows an example of a secure physical document according to embodiments of the invention;

FIG. 4 shows an example of a method of authenticating a secure document according to embodiments of the invention;

FIG. 5 shows an example portion of a document with errors highlighted;

FIG. 6 shows an example portion of a document with corrections highlighted; and

FIG. 7 shows an example of a data processing system.

### DETAILED DESCRIPTION OF EMBODIMENTS OF THE INVENTION

Embodiments of the invention provide methods and/or systems for securing physical documents and for authenticating secure physical documents that have been secured using embodiments of the invention. Embodiments of the invention secure a physical document, such as a document printed or written on paper or some other physical medium, by associating a machine-readable marking with the physical document. The machine readable marking comprises, for example, a barcode and includes at least one error detection code, such as, for example, an error correction code or a checksum.

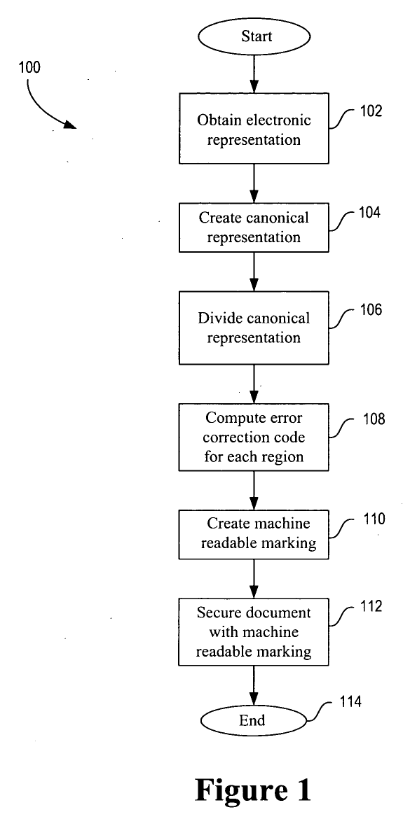

FIG. 1 shows an example of a method 100 of securing a physical document according to embodiments of the invention. The method starts at step 102 where an electronic representation of at least part of the physical document is obtained. This may be done, for example, by scanning the document using a scanner. The electronic representation comprises, for example, an image of the electronic document.

Next, in step 104, a canonical representation (image data) of at least part of the electronic representation is created. The canonical representation will be used as the basis for creating one or more error detection codes associated with the document. The canonical representation may cover the whole of the electronic representation. However, it may only be necessary to provide error detection codes in respect of only part of the physical document. For example, where the document is a form or a certificate, or similar physical documents contain similar parts such as logos and/or text or and/or include areas that do not convey information, these areas may be omitted from the electronic representation and/or the canonical representation. For example, only relevant parts of the physical document are provided in the electronic representation, or only the relevant parts are included within the canonical representation. The physical document may include fiducial marks that indicate which parts of the physical document are relevant.

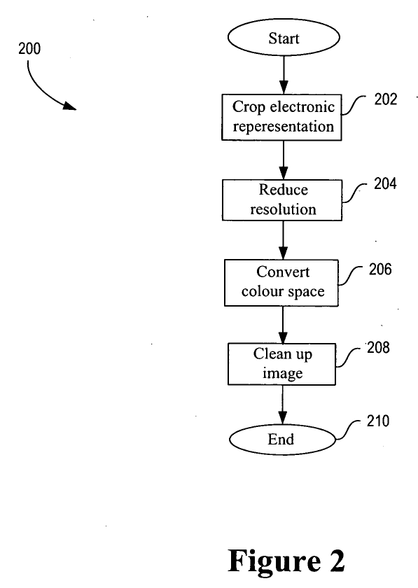

The canonical representation is created using, for example, a method 200 shown in FIG. 2. The method 200 starts at step 202 where the electronic representation is cropped if desired, to omit parts of the electronic representation that may not be relevant, producing image data. Where the electronic representation is not cropped, the image data comprises the electronic representation. Then, in step 204, the resolution of the resulting image data is reduced, if desired, and any smoothing, filtering or interpolation techniques may be employed to obtain an accurate reduced resolution image. Next, in step 206, the colour space of the image data is converted such that fewer colours are represented. This may allow an error detection code associated with the image data to detect more errors in the image data for the same size of error detection code, or detect the same number of errors for a smaller error detection code, as the colour information in the image data may not be significant. For example, the physical document may comprise black text on a white physical medium, and two colours may be sufficient to represent relevant information on the physical document.

For example, the colour space of the image data may be reduced to two colours using thresholding.

Once the colour space has been reduced in step 206 of the method 200, the image data is cleaned up in step 208. Cleaning up the image may comprise, for example, removing isolated pixels. The method 200 then ends at step 210.

Referring back to FIG. 1, once the canonical representation (the image data) has been created in step 104, the canonical representation is divided into regions in step 106. Each region will be associated with its own error detection code. The regions may be, for example, predefined rectangular regions of equal size distributed evenly across the canonical representation. Alternatively, however, the regions may vary in size and/or shape across the canonical representation and/or between different canonical representations of different physical documents.

Once the canonical representation has been divided up into regions in step 106, an error detection code is created for each region in step 108. The error detection code may comprise a code that indicates that errors are present in the associated region. The error detection code may alternatively comprise an error correction code that allows at least some of the errors in the associated region to be corrected. For example, the error detection code may comprise a checksum or a hash function value of the values of the pixels in the associated region, or may include error correction features such as a Reed-Solomon code. Other error detection codes (including error correction codes) may be used in alternative embodiments of the invention. Where an error correcting code is used, the number of errors that can be detected and corrected in the bit stream of the image data of the associated region typically depends on the size of the error correcting code, where a larger error correcting code can detect more errors. Therefore, there is a trade off between detecting more errors and keeping the size of the error correcting codes down. A larger error correcting code may result in a larger machine-readable marking, which is explained in more detail later in this document.

Once the error correcting codes have been computed in step 108, an electronic representation of a machine readable marking is created in step 110. The machine readable marking contains all of the error detection codes computed in step 108. For example, the error detection codes may be concatenated to form a string of data (such as a string of bits) that can then be included in the machine readable marking. The machine readable marking may also include other information such as, for example, information on the number and location of the regions, the identity of the sender and/or receiver of the document if it is to be communicated, the date and time that the machine readable marking was created and keywords. Information about the number and location of the regions may be alternatively provided by the use of fiducial markings on the document. Keywords may indicate the contents of the physical document, such that when the machine-readable marking is subsequently read by, for example, a data processing system, the document can be identified and/or archived and/or the keywords can be stored to facilitate searching for the physical document. The electronic representation of the machine readable marking may comprise, for example, an image of the document that can be printed and/or displayed, the image including the machine-readable marking, or an image of the machine-readable marking that can later be applied to the document or an image thereof.

The machine readable marking may also include a digital signature to prevent tampering of the machine readable marking, or that is usable to indicate tampering. For example, the digital signature may be created by encrypting the rest of the machine readable marking with a private key such that it can be verified by a corresponding public key.

Once the electronic representation of the machine-readable marking is created in step 110, the physical document is secured in step 112. This may involve printing a new, secure physical document that includes the electronic representation and also the machine-readable marking. Alternatively, the machine-readable marking may be printed onto the physical document, such that the physical document becomes a secure physical document. The machine-readable marking may be positioned at the same position on all secure physical documents, such as, for example, within a margin, or alternatively may be positioned at different positions between different secure physical documents. The machine readable marking may include means for locating the marking such as, for example, fiducial marks around the machine readable marking. The machine readable marking may comprise, for example, a 2D barcode according to the PDF417 (ISO/IEC 15438) specification, although any other format for the machine readable marking may be used in alternative embodiments.

Once the secure document has been created in step 112, the method 100 ends at step 114.

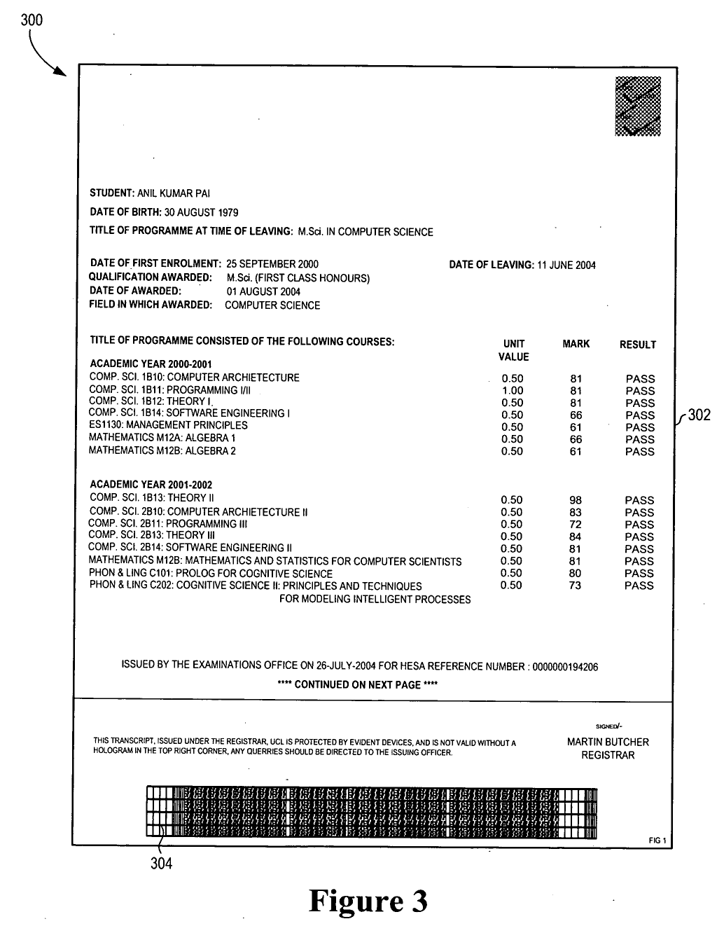

FIG. 3 shows an example of a secure document 300. The document comprises a certificate and includes a human-readable portion 302 and a machine-readable marking 304.

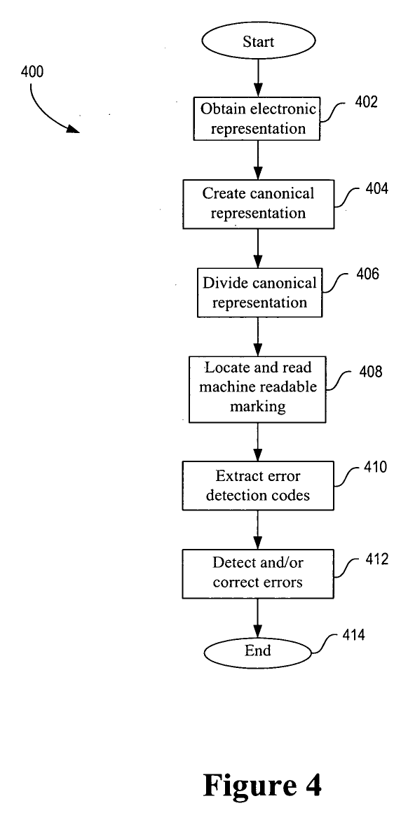

FIG. 4 shows an example of a method 400 for authenticating a secure physical document according to embodiments of the invention. For example, where the secure physical document 300 is sent to a recipient, the recipient may execute the method 400 to authenticate the document and/or detect and/or correct errors in the document. The errors may include, for example, changes made to the document as a result of malicious tampering. The method 400 starts at step 402. The steps 402, 404 and 406 of the method 400 are identical to the steps 102, 104 and 106 respectively of the method 100 of FIG. 1, except that the steps 402, 404 and 406 are carried out in respect of the secure physical document. Thus, a number of regions of a canonical representation of the document are formed. The electronic representation of the secure physical document and/or the canonical representation of the secure physical document may omit the machine readable marking on the secure physical document.

In alternative embodiments of the invention, some or all of the information relating to the canonical form and the regions formed therefrom can be included within the machine readable marking. For example, information on the location and/or number of regions can be included, and/or information on how the canonical representation was formed to secure the secure physical document can be included. Information on how the canonical representation was formed may include, for example, the resolution, colour space, area of the document covered by the canonical representation, threshold level and/or other information.

Next, in step 408, the machine readable marking is located within the electronic representation of the secure physical document obtained in step 402 and read. The machine-readable marking may include error correction information that can be used to correct any errors in reading the machine readable marking and/or any errors in the electronic representation that occur in the region of the machine readable marking. Any digital signature that is present in the machine-readable marking may be used to verify that the machine readable marking has not been tampered with.

Next, in step 410, the error detection codes are extracted from the machine readable marking, and then in step 412 the error detection codes are applied to the associated regions to detect and/or correct errors in the regions. For example, an error detection code may be used to indicate the number of errors in the region associated with the error detection code. For example, a region of the canonical representation of the secure physical document may comprise a bit stream of black and white pixels. The error detection code may be used to indicate the number of errors in the bit steam when compared to the bit stream determined for the same region in respect of the physical document in the method 100 of FIG. 1.

The secure document may be classed as insecure if, for example, any region thereon contains an unacceptably high number of errors. The errors may include, for example, errors that arise when obtaining the electronic representation of the secure physical document. The presence of a large number of errors, however, may indicate that the human readable part of the secure physical document has been tampered with.

Where the document includes error correction codes, the errors in the regions covered by the error correction codes may be corrected and/or the position of the errors in those regions can be determined. The errors and/or corrections may then be highlighted to a user. For example, the electronic representation of the document obtained in step 402 may be amended to highlight the pixels that were detected in step 412 as being erroneous and then printed. Alternatively, the pixels may be corrected and then highlighted, and then the electronic representation may be printed. Additionally or alternatively, the pixels may be highlighted in other ways, such as, for example, on a display device of a data processing device. The pixels may be highlighted on one or more of a number of ways, such as, for example, displaying and/or printing the erroneous pixels in a different colour than the rest of the pixels or displaying and/or printing a box around groups of erroneous pixels. Words, alphanumeric characters (such as letters or numbers) or parts of alphanumeric characters added by writing/printing after computing error correcting codes could constitute an attempt at fraud. Similarly, material deleted after the error correcting codes were computed could constitute an attempt at fraud. Different colors can be used in certain embodiments of the invention, if desired, to display evidence of these two types of manipulation, visibly differentiating the two cases.

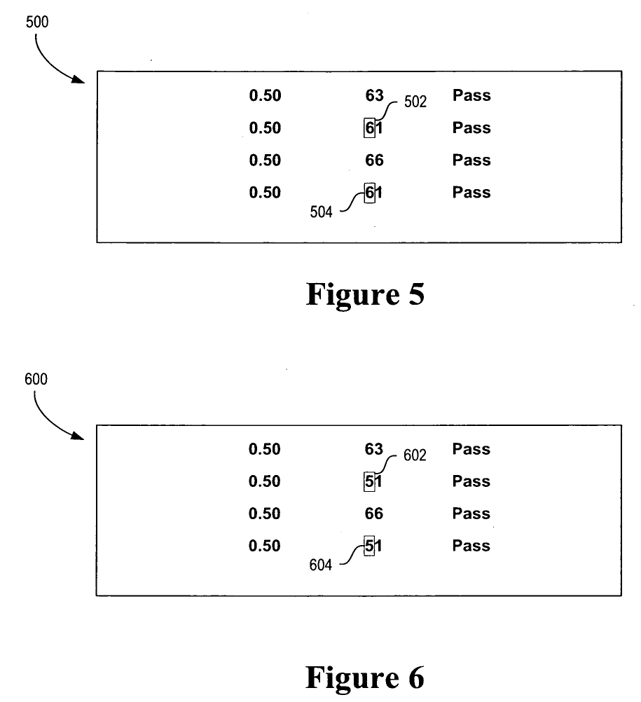

FIG. 5 shows an example of a portion 500 of the document 300 of FIG. 3. The portion 500 includes two highlights 502 and 504, indicating groups of pixels that have been detected as being erroneous using an error correction code. The highlights 502 and 504 comprise a box around a group of erroneous pixels. A user may be able to view the highlighted areas of the portion 500 and decide whether the highlighted areas may have been the result of tampering. In this case, two numbers on the portion 500 of the document 300 are highlighted, and these numbers may have been changed by a malicious person.

FIG. 6 shows an example of a portion 600 of the document 300 of FIG. 3. The portion 600 includes two highlights 602 and 604. The highlights 602 and 604 comprise a box around a group of erroneous pixels. The pixels within the highlighted areas are different to those shown in the corresponding portion of the document 300, and contain corrected pixels. Therefore, a user can see which parts of the secure physical document 300 contain incorrect pixels and what the corrected document should look like. In this case, the two highlighted numbers are the correct numbers and the corresponding numbers on the secure physical document 300 are erroneous, and may have been tampered with.

It may be the case that there are too many errors in one or more regions to be corrected using the error correction codes. In that case, this region of the document may have been maliciously manipulated. There may not be a reliable way to indicate that the errors in the canonical representation are as a result of factors other than tampering, such as natural errors arising when obtaining the electronic representation of the secure physical document. Alternatively, other information (other than error correction codes) if provided as a part of the content of the machine readable marking may be used to indicate the original information intended by the issuer of the documents. For example, some or all of the text may be included within the machine-readable marking as alphanumeric character data. This data may have been created, for example, using optical character recognition (OCR) at the time that the physical document was being secured with the machine-readable marking.

Once the errors in the canonical representation of the secure physical document have been detected and/or corrected in step 412 of the method 400 of FIG. 4 as indicated above, the method 400 ends at step 414.

Thus, embodiments of the invention can be used to indicate manipulations and/or errors in documents and may also indicate the location of the errors and/or indicate what the corrected document should look like.

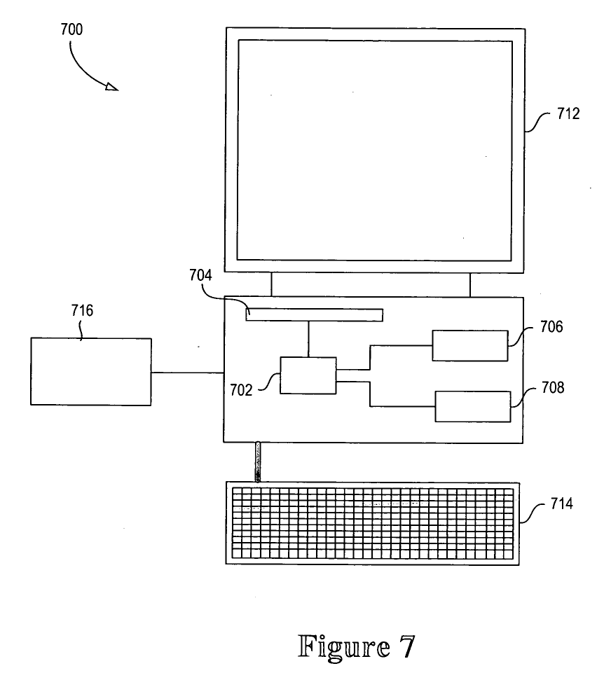

FIG. 7 shows an example of a data processing system 7 suitable for implementing embodiments of the invention. The data processing system 700 includes a data processor 702 and main memory 704 such as RAM. The data processing system 700 may also include a storage device 706 such as a hard disk and/or a communications device 708 for communicating with a wired and/or wireless network such as a LAN WAN and/or the Internet. The system 700 may also include a display device 710 and/or an input device 712 such as a mouse and/or keyboard.

The data processing system 700 may also include a scanner 714 for obtaining an electronic representation of a physical document and/or a secure physical document. In alternative embodiments, however, at least some or all of the functionality of embodiments of the invention may be implemented in a single device such as, for example, an all-in-one (AiO) device or multifunction printer/scanner device.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of authenticating a physical document, comprising:
obtaining an electronic representation of at least part of the physical document;
extracting at least one error detection code from the electronic representation; and
using the at least one error detection code to detect errors in image data within the electronic representation.

2. A method as claimed in claim 1, wherein the at least one error detection code comprises at least one error correction code including redundant data.

3. A method as claimed in claim 2, comprising correcting one or more errors in the image data using the at least one error correction code.

4. A method as claimed in claim 1, comprising printing at least the image data and highlighting the detected errors.

5. A method as claimed in claim 1, wherein obtaining the electronic representation comprises scanning the at least part of the physical document.

6. A method as claimed in claim 1, wherein extracting the at least one error detection code comprises reading a machine readable marking within the electronic representation.

7. A method as claimed in claim 6, comprising verifying the machine readable marking using a digital signature embedded within the machine readable marking.

8. A method as claimed in claim 1, wherein extracting the at least one error detection code comprises extracting an error detection code for each of a plurality of predefined regions of the electronic representation.

9. A method as claimed in claim 1, comprising reducing at least one of the resolution and the number of colours of at least part of the electronic representation to form the image data.

10. A method of securing a physical document, comprising:
obtaining an electronic representation of at least part of the physical document;
determining at least one error detection code for image data within the electronic representation; and
producing a secure physical document comprising the electronic representation and a machine readable marking including the at least one error detection code.

11. A method as claimed in claim 10, wherein determining the at least one error detection code comprises determining an error detection code for each of a plurality of predefined regions within the electronic representation.

12. A method as claimed in claim 10, wherein obtaining the electronic representation comprises scanning the at least part of the physical document.

13. A method as claimed in claim 10, wherein the at least one error detection code comprises at least one error correction code.

14. A method as claimed in claim 10, wherein producing the secure physical document comprises printing the electronic representation and the machine readable marking.

15. A method as claimed in claim 10, wherein producing the secure physical document comprises printing the machine readable marking onto the physical document.

16. A method as claimed in claim 10, comprising reducing at least one of the resolution and the number of colours of at least part of the electronic representation to form the image data.

17. A physical document comprising a machine readable marking including at least one error detection code for detecting errors within an electronic representation of the secure physical document.

18. A physical document as claimed in claim 17, wherein the at least one error detection code comprises at least one error correction code for correcting errors within the electronic representation.

19. A physical document as claimed in claim 17, wherein the at least one error detection code comprises an error detection code for each of a plurality of predefined regions of the physical document.

20. A system for implementing the method as claimed in any of claims 1, 10 and 17.

21. A computer program for implementing the method as claimed in any of claims 1, 10 and 17.

22. Computer readable storage storing a computer program as claimed in claim 21.
